(19) United States
(12) Patent Application Publication
(10) Pub. No.: US 2006/0103718 A1
(43) Pub. Date: May 18, 2006

(54) Variable interlace system and method of use

(75) Inventor: Anthony Ang, Long Beach, CA (US)

Correspondence Address: PILLSBURY WINTHROP SHAW PITTMAN, LLP, P.O. BOX 10500, MCLEAN, VA, 22102, US

(73) Assignee: Xerox Corporation

(21) Appl. No.: 10/991,801

(22) Filed: Nov. 18, 2004

(51) Int. Cl. B41J 2/455

(52) U.S. Cl. 347/233

(57) ABSTRACT

A variable interlacing system for use in xerographic imaging. Variable interlacing provides automatic reconfiguration of imaging parameters in an electrostatic printing machine. Print speed, format and resolution of the printed material may be traded-off against each other dynamically and on demand without changing any of the hardware, including the Raster Output Scanner (ROS). The system and the method of use of the system involve multi-beam irradiative sources in the ROS.

### BACKGROUND

Disclosed is a variable interlacing system for use in xerographic imaging. Variable interlacing provides automatic reconfiguration of imaging parameters in a printing machine. Print speed, format and resolution of the printed material may be traded-off against each other dynamically and on demand without changing any of the hardware, including the Raster Output Scanner (ROS).

Xerography is an electrostatic printing process where a latent image is formed on a specially coated charged surface, sometimes referred to as a photoreceptor, by the action of light, and the latent image is developed with powders that adhere only to electrically charged areas. One xerographic imaging process involves an array of laser sources irradiating an array of micromechanical mirrors to image a series of spots onto a moving photoreceptor. Spots form the basis of an image on the photoreceptor, and interlacing involves the sequence of forming of a series of spots on the photoreceptor.

Lasers or light emitting diodes (LEDs) may be used to expose spots on the photoreceptor. The photoreceptor has the property of holding an electrical charge in the absence of light. Illumination of a spot on the photoreceptor by a laser or LED causes the loss of charge at the exposed spot. In a typical xerographic system, charge left on the photoreceptor attracts toner that is then transferred to paper which has a greater charge than the photoreceptor. Single spot raster output scanning (ROS) print engines are known in the art.

FIG. 1 shows a typical single spot polygon ROS printer 10. The printer generally comprises a laser light source 20, a modulator 30, a polygonal scanning beam deflector mirror 40, pre-scan optics 37, post-scan optics 47, a flying spot scanner 50, xerographic printing engine 60 and the electronics 15 to control the printer operation. In operation, spot scanner 50 scans data modulated light beam 55 over a xerographic photoreceptor 65 as shown in FIG. 1 in accordance with a predetermined raster scanning pattern.

A motor (not shown) rotates the polygon mirror about its central axis 41, as indicated by the arrow 43, at a substantially constant angular velocity. Polygon mirror 40 is optically aligned between laser 20 and photoreceptor 65 so that its rotation causes the laser beam 25 to be intercepted by and reflected from one after another of the mirror facets 45. As a result, beam 25 is cyclically swept across the photoreceptor 65 in a fastscan direction. Photoreceptor 65, on the other hand, is advanced (by means not shown) simultaneously in an orthogonal, process direction at a substantially constant linear velocity, as indicated by arrow 63 so that the laser beam 55 scans the photoreceptor 65 in accordance with a raster scan pattern. As shown, the photoreceptor 65 is coated on a rotating drum 60, though it will be apparent that it also could be carried by a belt or any other suitable substrate. Pre-scan and post-scan optics, 37 and 47, respectively, of ROS systems are well known in the art for providing any optical correction that may be needed to compensate for scanner wobble and other optical irregularities, and as they are not significant to the invention, they are not described in detail here in order not to unnecessarily obscure the present disclosure.

A flying spot scanner is described by Curry in U.S. Pat. No. 5,382,967. The scanner provides printing capability with a continuously tunable ROS. In another U.S. Pat. No. 5,638,107, Curry discloses a system for performing interlace scanning and formatting with plural light beams. However, it will be known to those skilled in the art of ROS systems that in order to maintain a particular resolution of an image on a photoreceptor of a certain speed, the rotation of the polygon mirror must also be maintained at a relatively constant rotational speed commensurate with the unvarying interlacing scheme of the present state of the art. It is desirable to be able to vary the resolution of the output image independent of the other parameters of the ROS system, such as the thruput of writing on the photoreceptor and the format of the printed material.

### SUMMARY

Aspects disclosed herein include

an apparatus comprising an electrostatic imaging station having a Raster Output Scanner (ROS); a data processing apparatus associated with said ROS; a photoreceptor configured to interact with said imaging station; one or more image data files in said electronic data modules to instruct a set of interlacing factors to said ROS; and one or more arrays of irradiative sources to execute said interlacing factors.

an apparatus comprising a Multi-Beam Raster Output Scanner (MBROS); a photoreceptor configured to interact with said MBROS; an electronic data module capable of interfacing with said MBROS; one or more image data files in said electronic data module to instruct a set of variable interlacing factors to said MBROS; and one or more beams to execute said interlacing instructions.

a method comprising creating an image file; assigning portions of said image file into buffers; mapping said image files into interlacing factors; directing said interlacing factors to a ROS; forming images on a photoreceptor corresponding to said interlacing factors; and printing images with different resolutions at different photoreceptor and ROS speeds, and any combinations thereof.

### BRIEF DESCRIPTION OF DRAWINGS

FIG. 1 is a schematic drawing of a single beam Raster Output Scanner (ROS) showing the xerographic imaging of a single spot on a photoreceptor.

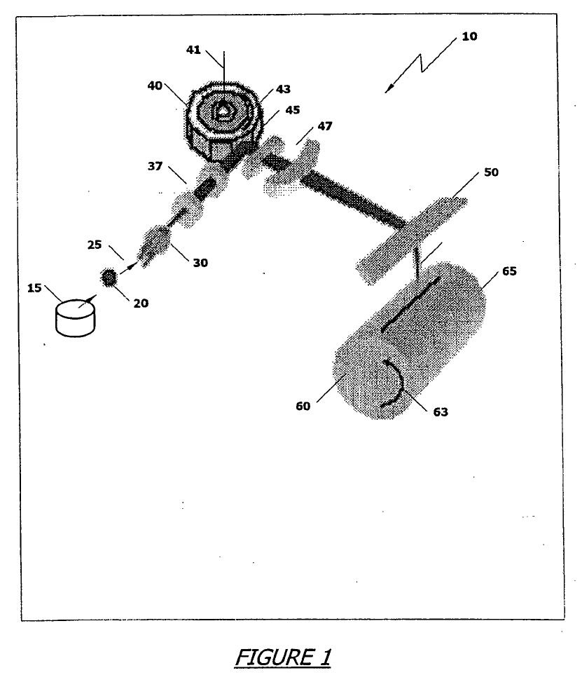

FIG. 2 is a schematic drawing of an embodiment of a xerographic printing machine showing the various electronic modules that direct the ROS system of the machine to print materials at different speeds and different resolutions based on variable interlacing factors that are commanded by the electronic modules.

FIG. 3 is a schematic drawing of an embodiment of an interlace scheme showing the printing pattern corresponding to an interlace factor I(1) with a print resolution of 1200 dots per inch.

FIG. 4 is a schematic drawing of an embodiment of an interlace scheme showing the printing pattern corresponding to an interlace factor I(2) with a print resolution of 2400 dots per inch.

FIG. 5 is a schematic drawing of an embodiment of an interlace scheme showing the printing pattern corresponding to an interlace factor I(3) with a print resolution of 3600 dots per inch.

FIG. 6 is a schematic drawing of an embodiment of a Multi-Beam Raster Output Scanner (MBROS) showing the xerographic imaging of one or more optic spots on a photoreceptor as illuminated by an array of Vertical Cavity surface Emitting Laser (VCSEL) beams.

### DETAILED DESCRIPTION

In embodiments there is illustrated:

a system for enabling multiple print speeds and resolutions by changing the interlace factor without any change to the ROS hardware. The system involves a multiple VCSEL (vertical cavity surface emitting laser) source array with which resolution and print speed can be traded off against each other in ROS printers by changing the interlace addressing schemes on-the-fly. The interlace scheme can be dynamically changed while keeping the same optical magnification through electronic data manipulations. To accommodate different slow scan addressability schemes, either the xerographic process speed or the ROS motor speed can be changed.

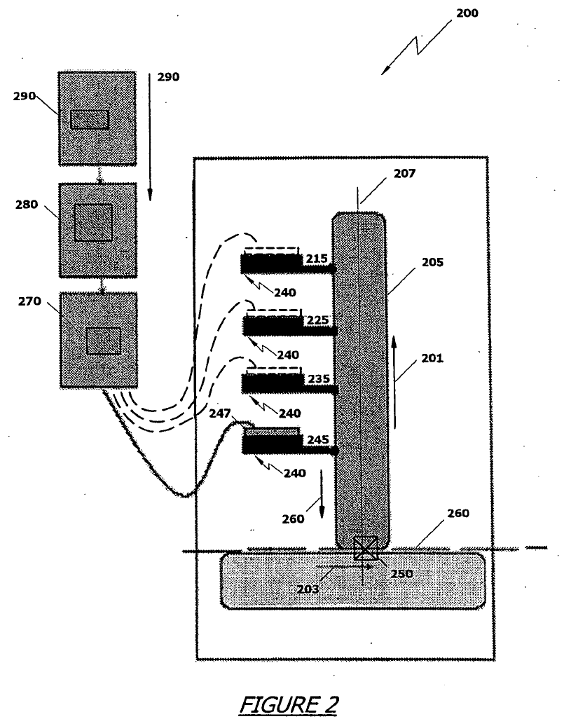

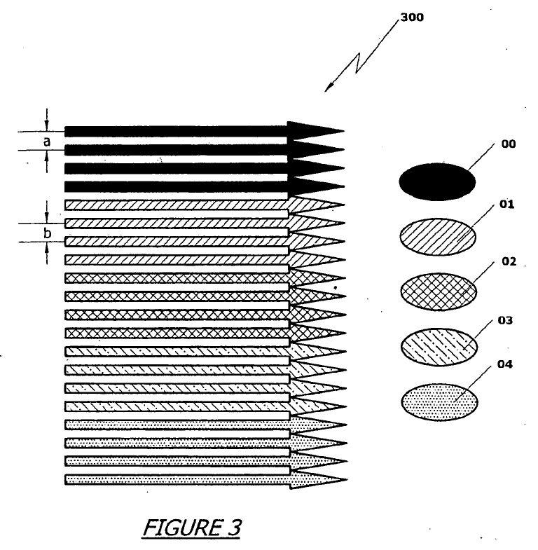

FIG. 2 depicts an input-output-terminal (IOT) 200 of an electrophotographic printing machine such as the Xerox iGen3®, which is incorporated here in its entirety as described in U.S. Pat. No. 6,788,904. An embodiment of the present disclosure as shown in FIG. 2 utilizes ROS systems 215, 225, 235 and 245 comprising, but not limited to, an array of multiple VCSEL beams which makes possible to vary printing speed and resolution by varying interlacing dynamically, as described further in FIGS. 3-5. It will be understood that other irradiative beams, such as from side-light-emitting diodes (LEDs) or electron beams may be used to constitute multi-beam ROS (MBROS).

The printing machine architecture shown in FIG. 2 includes, but not limited to four processing stations and a photoconductive belt, or photoreceptor 205 that interacts with a ROS at each station. Photoreceptor 225 is arranged in a vertical orientation with vertical axis 207. Photoreceptor 225 advances in the direction of arrow 201 to move successive portions of the external surface of photoreceptor 225 sequentially beneath the various processing stations 210, 220, 230 and 240 disposed about the path of movement thereof. Although processing stations 210, 220, 230 and 240 are shown to one side of the vertical axis 207, it will be understood that similar stations could be positioned on the opposing side adjacent the photoreceptor 205.

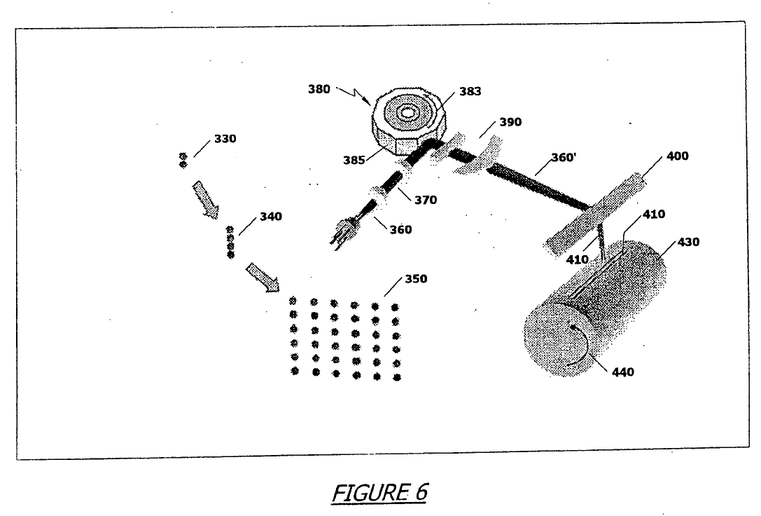

Each of the four processing stations 210, 220, 230 and 240 shown in FIG. 2 comprises, in addition to a representative VCSEL ROS shown in FIG. 6, a charging unit and a developer unit, which are well known in the art and, therefore, are not shown here in order not to unnecessarily obscure the FIG. 2. Suffice to say that initially, photoreceptor passes through first station 210 where the charging unit charges the exterior surface of the photoreceptor 205 to a uniform potential. Afterwards, the charged portion thereof advances to exposure ROS device 215 (shown in more detail in FIG. 6), which illuminates the charged portion of the exterior surface of photoreceptor 205 to record first electrostatic latent image thereon. This first electrostatic latent image is developed by a developer unit (not shown). Developer unit deposits toner particles of a selected color, in this instance, magenta color, on the first electrostatic latent image. After the toner image has been developed on the exterior surface of photoreceptor 205, the photoreceptor continues to advance counterclockwise in the direction of arrow 201 to the second station 220.

The process described above is repeated at the subsequent stations 220, 230 and 240 where the second, third and fourth electrostatic latent images are recorded, then exposed by respective VCSEL ROSs 225, 235 and 245 followed by depositing and developing toner particles in yellow, cyan and black, respectively. The black toner particles form a black toner powder image which may be partially or totally in superimposed registration with the previously formed cyan, yellow and magenta toner powder images. In this manner, a multi-color toner powder image is formed on the exterior surface of photoreceptor 205. Thereafter, photoreceptor 205 advances the multi-color toner powder image to a transfer station, indicated generally by the reference numeral 250. A receiving medium 260, e.g., paper, is advanced by sheet feeders (not shown) and guided to transfer station 250, where a corona generating device (not shown) sprays ions onto the back side of the paper. This attracts the developed multi-color toner image from the exterior surface of photoreceptor 205 to the sheet of paper. The photoreceptor 205 is then stripped away from the paper 260 having the toner image. A vacuum transport moves the sheet of paper 260 in the direction of arrow 203 to a fusing station (not shown). In the fusing operation, the toner particles coalesce with one another and bond to the sheet in image configuration, forming a multi-color image thereon. After fusing, the finished sheet is discharged to be collected by the printing machine operator.

The latent images that are recorded on photoreceptor 205 through exposure of the photoreceptor 205 by VCSEL ROSs 215, 225, 235 and 245 at their respective process stations 210, 220, 230 and 240 are governed by digital data provided at their respective ROS control modules (RCM) 217, 227, 237 and 247 shown in FIG. 2. RCM serves the function of an interface between the electronics that operate the printing machine and ROS, which performs electronic image printing on the photoreceptor. Accordingly, each RCM drives, or modulates its laser beam or beams to form a latent image on the photoreceptor 205 resulting in a the final output multi-color toner image as a composite of the magenta, yellow, cyan and black toner images that were recorded by their respective VCSEL ROS.

Using ROS control module 247 as exemplary of the other RCMs 237 227 and 217, RCM 247, like the others, receives pixel data from raster image module (RIM) 270, which in turn, receives a binary image (pixel) file from a contone rendering module (CRM) 280. (As is known in the art, contone rendering involves a combination of dithering-creating the illusion of new colors and shades by varying the pattern of dots- and printing at different levels of intensity to produce different colors and different shades of lightness and darkness). CRM 280 maps a binary image (pixels) file from the gray scale level for halftones, as interpreted by a digital front end (DFE) 290 of the electronics that controls the operation of the printer. DFE 290 interprets the various electronic files that command the processing of an image by the printer. The image data can be grayscale converted to multiple bits per pixel, or may be provided in binary format (i.e., one bit per pixel).

DFE 290 interprets the type of document (file type). The interpreted information includes whether or not the image is in color or black/white, the resolution of the image and whether the image is text or picture. This process is sometimes referred to as tagging an image. DFE also converts the information to a uniform file type that CRM 280 can understand. The information may then be used to set the parameters of the printing machine on demand and “on-the-fly”, as described more in detail later.

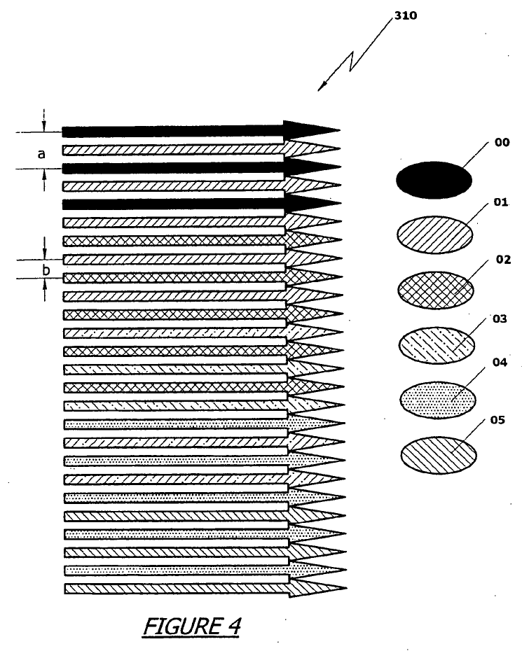

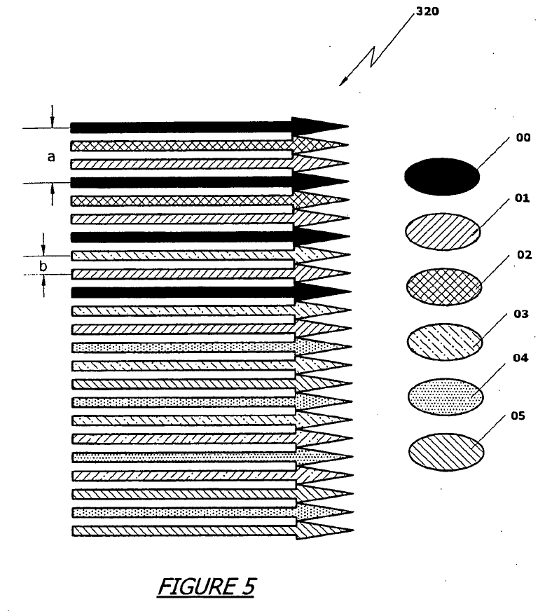

Interlacing involves exposing adjacent lines of dots of a particular color during sequential scans by a ROS. For example, odd numbered lines 1, 3, 5, etc., may be exposed during first scan, and even numbered lines 2, 4, 6, etc., during the next scan. In an embodiment, FIG. 3 shows Interlace I(1) scheme 300 where a given image file is processed as is. That is, each image line is exposed one after another in a sequential manner (scans 0, 1, 2, 3, 4) as shown in FIG. 3. FIG. 4 shows Interlace II(2) scheme 310 where the image file is split between odd and even lines into separate buffers say, A and B. The odd and even files are adjusted for location differences. With a ROS having an array of “n” number of VCSELS, for example, the even file prints its first beam “n” line locations below the first line. With Interlace III(3) scheme 320 shown in FIG. 5, the image file is split into 3 parts (buffers A, B and C). Following the same process as in the Interlace II scheme before, every 3^{rd} line goes to its respective buffer and the image in buffer B occurs “n” number of lines below those of buffer A. Similarly, the pattern corresponding to the image data in buffer C will be “n” lines below buffer B. As an exemplary, for n=31, and with beam to beam spacing “a” of 21.17 microns (μm), Interlace I in FIG. 3 yields a resolution of 1200 lines per inch (Ipi), while Interlace II in FIG. 4 yields a resolution of 2400 Ipi, and Interlace III in FIG. 5, 3600 Ipi with the corresponding line to line spacing “b” of about 21.17, 10.58 and 7.055 μm, respectively.

A ROS capable of executing a reconfigured set of instructions received from the DFE of FIG. 2 is shown in FIG. 6. FIG. 6 shows an embodiment of an arrangement of an array of multi-beams in a multi-beam ROS (MBROS) or a multispot ROS system. The array shown comprises, but not limited to, an 8×4 array of VCSEL beams. It will be understood from FIG. 6 that the light source for the multiple ROS system can range from a dual spot laser 330 to quad spot laser 340 to a VCSEL array 350 having 32 to 36 spots, or larger arrays. The multiple numbers of beams 360 emanating from the array 350 of VCSELs are deflected 360′ by polygon mirror 380 as shown in FIG. 6. A motor (not shown) rotates the polygon as indicated by arrow 383, at a substantially constant angular velocity. Polygon mirror 380 is optically aligned between VCSEL array 350 and photoreceptor 430 so that its rotation causes one or more laser beams 360 to be intercepted by and reflected from one after another of the mirror facets 385. As a result, beams 360′ are cyclically swept across the photoreceptor 430 in a fastscan direction. Photoreceptor 430, on the other hand, is advanced (by means not shown) simultaneously in an orthogonal, process direction at a substantially constant linear velocity, as indicated by arrow 440 so that band of laser beams 410 scans the photoreceptor 430 in accordance with a raster scan pattern issued by ROS control module (RCM) 247 of FIG. 2. Pre-scan and post-scan optics, 370 and 390, respectively, of ROS systems are used to compensate for scanner wobble and other optical irregularities, as stated earlier. It will be noted in FIG. 6 that reference numeral 410 shows a multiplicity of beams representing one or more optic spots rather than a single spot beam.

Returning to FIG. 2, an embodiment involves one or more digital image files that traverse a path 295 from the electronics to the photoreceptor 205 of the printing machine schematically shown in the same Figure. As an exemplary, if the file information at the digital front end (DFE) 290 is tagged as low resolution at 1200, 600 or 300 dots per inch (dpi), and it is in black/white, then the system can be set to print at a higher page rate. The trade off between speed and resolution can be governed by changing the interlacing factor of the ROSs 215, 225, 235 and 245 at the process stations 210, 220, 230 and 240 of FIG. 2. For text files, the 600 dpi may be rendered with 2×2 pixels per dot. The 300 dpi may be rendered with 4×4 pixels per dot.

Along the same digital path 295, at the contone rendering module (CRM) 280 in FIG. 2, if the contone resolution is 106 lines per inch, and the ROS resolution is 1200×1200 dpi, the number of ROS lines to create each grid of contone cells becomes 16. The number of ROS pixels is 136 per contone cell. The contone to pixels conversion is as follows:

| Contone (lpi) | ROS (dpi) | Lines | Pixels |
|---|---|---|---|
| 106 | 1200 | 16 | 1336 |
| 106 | 2400 | 32 | 528 |
| 212 | 1200 | 8 | 36 |
| 212 | 2400 | 16 | 136 |

It will be noted that the conversion given above is based on a 45-degree contone screen angle. As is known in the art, for other color stations other angles must be used in order for the repetitive frequency patterns not to have Moiré (beating patterns) with each other. At different contone and resolutions, different number of grey levels are attained.

Following the digital path 295, the ROS interface module (RIM) 270 receives the binary files from CRM 280. RIM codifies the interlace factors which are dependent upon the desired print resolution and comprise the following resolution elements:

Interlace Factor (I)

| | 1 | 2 | 3 | 4 |
|---|---|---|---|---|
| Print Resolution (dpi) | 1200 | 2400 | 3600 | 4800 |

In an aspect of an embodiment described earlier, with 31 VCSEL beams shown in FIG. 6 and interlace factor 2 (2400 dpi), the even file prints its first beam 31 line locations below the odd file. With the same number of beams and interlace factor 3 (3600 dpi), the file is split into 3 parts, namely, buffers A, B and C. Buffer B wires (exposes) 31 lines below buffer A and buffer C writes 31 lines below buffer B. Interlace 4 follows the same pattern where the file is split into 4 parts. It will be noted that no further processing is needed for interlace 1 at the ROS interface nodule (RIM) 270. This is because, interlace factor of 1 produces simple sequential printing pattern with one buffer which outputs 31 lines at a time.

The raster output scanners (ROSs) 215, 225, 235, 245 in FIG. 2 and as described representatively in FIG. 6, prints (i.e., expose the photoreceptor 205) at a rate dictated by the video data stream (pixels) that come from the RIM 270 in each of the 31 channels corresponding to the 8×4 VCSEL array in FIG. 6, where the remaining one VCSEL is used to detect the start of scanning. Each channel creates 1 line of pixels in the scan direction.

Hence, it will be apparent now that there are one or more different ways to enable multiple print speeds and resolutions by changing the interlace factor dynamically “on-the-fly”. In one embodiment, one may:

1. adjust the photoreceptor speed;

2. adjust the polygon mirror speed; or

3. adjust both polygon and photoreceptor speed.

In another embodiment, the ROS hardware can be made modular so that different characteristics of print speed, resolution for the same printing machine, may be obtained simply by exchanging one ROS for another and/or reprogramming the image files to affect the desired characteristics by making changes to the software. It will be understood that the photoreceptor may move at different speed to change line spacing. The data rates coming from the RIM 270 in FIG. 6 may be changed to affect the scan direction pixel size.

It will be appreciated that variations of the above-disclosed embodiments and other features and functions, or alternatives thereof, may be desirably combined into many other different devices or applications. For example, the embodiments may be practiced with other radiation sources such as the electron beam. Also that various presently unforeseen or unanticipated alternatives, modifications, variations or improvements therein may be subsequently made by those skilled in the art which are also intended to be encompassed by the following claims.

What is claimed is:

1. An apparatus comprising
an electrostatic imaging station having a Raster Output Scanner (ROS);
a data processing apparatus associated with said ROS;
a photoreceptor configured to interact with said imaging station;
one or more image data files in said electronic data modules to instruct a set of interlacing factors to said ROS; and
one or more arrays of irradiative sources to execute said interlacing factors.

2. The apparatus in accordance with claim 1, wherein said data processing apparatus processes tagged image data files.

3. The apparatus in accordance with claim 1, wherein said interlacing factors comprise print resolution elements.

4. The apparatus in accordance with claim 1, wherein said irradiative sources comprise Vertical Cavity Surface Emitting Lasers (VCSELs).

5. An apparatus comprising
a Multi-Beam Raster Output Scanner (MBROS);
a photoreceptor configured to interact with said MBROS;
an electronic data module capable of interfacing with said MBROS;
one or more image data files in said electronic data module to instruct a set of variable interlacing factors to said MBROS; and
one or more beams to execute said interlacing instructions.

6. The apparatus in accordance with claim 5, wherein said MBROS comprises one or more laser beams, a scanning beam deflector and a flying spot scanner.

7. The apparatus in accordance with claim 6, wherein said laser beams comprise an array of Vertical Cavity Surface Emitting Laser (VCSEL) rays.

8. The apparatus in accordance with claim 5, wherein said scanning beam deflector comprises a polygonal mirror.

9. The apparatus in accordance with claim 8, wherein said polygonal mirror is optically aligned between said array of VCSELs and said photoreceptor.

10. The apparatus in accordance with claim 5, wherein said electronic data module comprises a ROS Control Module (RCM).

11. The apparatus in accordance with claim 10, wherein said RCM comprises said set of instructions to instruct said VCSEL beams to form latent images on said photoreceptor.

12. The apparatus in accordance with claim 5, wherein said interlacing factors comprise one or more resolution densities.

13. The apparatus in accordance with claim 5, wherein said resolution densities comprise multiples of 1200 dots per inch (dpi).

14. The apparatus in accordance with claim 5, wherein said polygonal mirror has a variable speed motor to accommodate one or more said resolutions densities.

15. The apparatus in accordance with claim 5, wherein said photoreceptor has a variable speed motor to accommodate one or more said resolutions densities.

16. The apparatus in accordance with claim 5, wherein said MBROS is capable of varying the photoreceptor speed or the polygon mirror speed, or both, in order to record images of different resolutions at different combinations of speeds.

17. A method comprising
creating an image file;
assigning portions of said image file into buffers;
mapping said image files into interlacing factors;
directing said interlacing factors to a ROS;
forming images on a photoreceptor corresponding to said interlacing factors; and
printing images with different resolutions at different photoreceptor and ROS speeds, and any combinations thereof.

18. The method in accordance with claim 17, wherein said assigning portions of said image file is accomplished by splitting image data between odd and even lines into separate buffers.

19. The method in accordance with claim 17, wherein said mapping is accomplished by tagging said image file and converting it to a uniform file type.

20. The method in accordance with claim 17, wherein said directing said interlacing factors to a ROS is accomplished with a ROS Control Module.

21. The method in accordance with claim 17, wherein said printing said images is accomplished by directing an array of laser beams in said ROS onto said photoreceptor, said beams being optically aligned with said photoceptor.
